(19) United States
(12) Patent Application Publication
(10) Pub. No.: US 2019/0301909 A1
(43) Pub. Date: Oct. 3, 2019

(54) THERMAL FLOW SENSOR DEVICE AND FLOW RATE CORRECTION METHOD

(71) Applicant: Azbil Corporation, Tokyo (JP)

(72) Inventors: Seishi NAKANO, Tokyo (JP); Masato TANAKA, Tokyo (JP)

(21) Appl. No.: 16/351,878

(22) Filed: Mar. 13, 2019

(30) Foreign Application Priority Data
Mar. 27, 2018 (JP) 2018-059302

(51) Int. Cl. G01F 1/696; G05D 7/06; G01F 1/684; G01F 1/692

(52) U.S. Cl. CPC G01F 1/6965; G01F 1/692; G01F 1/6842; G05D 7/0623

(57) ABSTRACT

A thermal flow sensor device includes a storing portion that stores information about the relationship between a valve opening and a flow rate, an instruction portion that transmits an instruction signal specifying at least two predefined valve openings to a controlling device that controls the valve, an acquiring portion that acquires the flow rate output value of the thermal flow sensor, a calculating portion that calculates the magnification between two flow rate output values acquired by the acquiring portion, acquires the magnification between the two flow rates corresponding to the two valve openings acquired from the storing portion, and calculates the ratio of the magnification between the two flow rates to the magnification between the two flow rate output values as the correction coefficient, and a correcting portion that corrects the flow rate by multiplying the flow rate output value of the thermal flow sensor by the correction coefficient.

### CROSS-REFERENCE TO RELATED APPLICATION

The present application claims the benefit of and priority to Japanese Patent Application No. 2018-059302, filed on Mar. 27, 2018, the entire contents of which are incorporated by reference herein.

### TECHNICAL FIELD

The present invention relates to a thermal flow sensor device that calculates the flow rate of a measurement fluid based on a sensor output signal acquired from a temperature sensor that measures the temperature of the measurement fluid.

### BACKGROUND

A thermal flow sensor that measures the flow rate of a fluid is in practical use (see, for example, PTL 1). The thermal flow sensor can measure (estimate) the flow rate of a measurement fluid (for example, water) to be assumed by grasping, in advance, the flow rate-output signal characteristics of the measurement fluid. Accordingly, when the measurement target is a fluid other than the measurement fluid for which the characteristics have been grasped in advance, the flow rate value acquired from the flow rate-output signal characteristics is corrected using a correction coefficient.

In the current method for using a thermal flow sensor, the correction coefficient is set via estimation by checking the thermophysical properties of a fluid or the sensitivity acquired when a similar fluid flowed in the past. This setting work needs to be substantially performed manually by the operator even when the procedure is standardized to some extent. Accordingly, the setting work needs effort and fluctuations easily occur due to the capability and personal view point of the operator, so improvement is necessary.

### CITATION LIST

### Patent Literature

[PTL 1] JP-A-2017-009348

### SUMMARY

The invention addresses the above problems with an object of providing a thermal flow sensor device and a flow rate correction method capable of reducing effort to set a correction coefficient and fluctuations in the correction coefficient.

A thermal flow sensor device according to the invention comprises a thermal flow sensor configured to output a sensor output signal acquired from a temperature sensor that measures a temperature of a measurement fluid, the thermal flow sensor being disposed in a flow channel through which the measurement fluid circulates; a valve opening-flow rate characteristic information storing portion configured to store, in advance, information about a relationship between an opening degree of a valve disposed in a part of the flow channel upstream or downstream of the thermal flow sensor and a flow rate of the measurement fluid; a flow rate-output signal reference characteristic information storing portion configured to store, in advance, information about a relationship between the sensor output signal and the flow rate in the measurement fluid used as a reference; a flow rate deriving portion configured to convert the sensor output signal to a value of the flow rate based on the information stored in the flow rate-output signal reference characteristic information storing portion; a flow rate correcting portion configured to correct the flow rate by multiplying a flow rate output value of the flow rate deriving portion by a correction coefficient; a valve opening instruction portion configured to transmit an opening degree instruction signal that specifies at least two predefined valve openings to a controlling device that controls the valve when the correction coefficient is calculated and set; an output signal acquiring portion configured to acquire the flow rate output value of the flow rate deriving portion when the valve opening in accordance with the opening degree instruction signal is achieved; and a correction coefficient calculating portion configured to calculate a magnification between two flow rate output values acquired by the output signal acquiring portion and acquire a magnification between two flow rates corresponding to the two valve openings acquired from the information in the valve opening-flow rate characteristic information storing portion, calculate a ratio of the magnification between the two flow rates to the magnification between the two flow rate output values as the correction coefficient, and set the calculated correction coefficient in the flow rate correcting portion.

In one example of the structure of the thermal flow sensor device according to the invention, the information stored in the valve opening-flow rate characteristic information storing portion stores the magnification between the two flow rates acquired based on a theoretical curve that approximates the relationship between the opening degree and the flow rate of the valve.

In addition, one example of the structure of the thermal flow sensor device according to the invention further comprises an execution managing portion configured to perform control and management so as to perform calculate and set processing of the correction coefficient at predefined timing; a history information presenting portion configured to present history information of the correction coefficient from past to present calculated by the correction coefficient calculating portion; and an alarm outputting portion configured to output an alarm when a deviation degree of the correction coefficient calculated by the correction coefficient calculating portion from a normal value is equal to or more than a defined amount.

A flow rate correcting method according to the invention comprises a first step of converting a sensor output signal of a thermal flow sensor disposed in a flow channel through which a measurement fluid circulates into a flow rate output value with reference to a flow rate-output signal reference characteristic information storing portion that stores, in advance, information about a relationship between a flow rate in the measurement fluid used as a reference and a sensor output signal; a second step of correcting the flow rate by multiplying the flow rate output value by a correction coefficient; a third step of transmitting an opening degree instruction signal that specifies at least two predefined valve openings to a controlling device that controls a valve disposed in a part of the flow channel upstream or downstream of the thermal flow sensor when the correction coefficient is calculated and set; a fourth step of acquiring the flow rate output value when a valve opening in accordance with the opening degree instruction signal is achieved; and a fifth step of calculating a magnification between two flow rate output values acquired in the fourth step, acquiring a magnification between two flow rates corresponding to the two valve openings with reference to a valve opening-flow rate characteristic information storing portion that stores, in advance, information about a relationship between an opening degree of the valve and the flow rate of the measurement fluid, and calculating a ratio of the magnification between the two flow rates to the magnification between the two flow rate output values as the correction coefficient.

In addition, in one example of the flow rate correcting method according to the invention, the information stored in the valve opening-flow rate characteristic information storing portion in advance is the magnification between the two flow rates acquired based on a theoretical curve that approximates the relationship between the opening degree of the valve and the flow rate of the measurement fluid.

In addition, one example of the flow rate correcting method according to the invention further comprises a sixth step of instructing execution of calculating and setting processing of the correction coefficient at predefined timing; a seventh step of presenting the history information of the correction coefficient from past to present calculated in the fifth step; and an eighth step of outputting an alarm when a deviation degree of the correction coefficient calculated in the fifth step from a normal value is equal to or more than a defined amount.

According to the invention, by providing the valve opening-flow rate characteristic information storing portion, the valve opening instruction portion, the output signal acquiring portion, and the correction coefficient calculating portion, effort to set the correction coefficient and fluctuations in the correction coefficient can be reduced. Accordingly, even an operator without having expertise in flow rate measurement can set a correction coefficient appropriate for the measurement fluid.

In addition, the invention can be expected to monitor the correction coefficient calculated and set by the correction coefficient calculating portion by providing the execution managing portion, the history information presenting portion, and the alarm outputting portion and detect the state change (such as occurrence of an abnormality) of the measurement fluid.

### BRIEF DESCRIPTION OF THE DRAWINGS

FIG. 1 is a drawing illustrating the relationship between an actual flow rate and a flow rate output of a thermal flow sensor when water is set as a measurement fluid and then various types of fluids circulate through the thermal flow sensor.

FIG. 2 is a block diagram illustrating the structure of a thermal flow sensor device according to a first embodiment of the invention.

FIG. 3 is a cross-sectional view illustrating a mass flow controller.

FIGS. 4(A) and 4(B) are a plan view and a cross-sectional view, respectively, that illustrate the structure of a flow sensor chip of the thermal flow sensor.

FIG. 5 is a block diagram illustrating the structure of an electric circuit of the thermal flow sensor.

FIG. 6 is a drawing illustrating one example of the relationship between the opening degree of a valve and the flow rate of a fluid.

FIG. 7 is a drawing illustrating the relationship between an actual flow rate and a sensor output signal when various types of fluids circulate through a flow channel.

FIG. 8 is a drawing illustrating the relationship between the sensor output signal and the actual flow rates of various types of fluids when using the characteristics of water in FIG. 7 as a reference.

FIG. 9 is a flowchart illustrating the operations of a valve opening instruction portion, an output signal acquiring portion, a correction coefficient calculating portion, and a correction coefficient setting portion of the thermal flow sensor device according to the first embodiment of the invention.

FIG. 10 is a flowchart illustrating the operations of a flow rate deriving portion and a flow rate correcting portion of the thermal flow sensor device according to the first embodiment of the invention.

FIG. 11 is a block diagram illustrating the structure of a thermal flow sensor device according to a second embodiment of the invention.

FIG. 12 is a flowchart illustrating the operations of a valve opening instruction portion, an output signal acquiring portion, a correction coefficient calculating portion, an execution managing portion, a history information presenting portion, and an alarm outputting portion of the thermal flow sensor device according to the second embodiment of the invention.

FIG. 13 is a drawing illustrating an example of presenting history information of a correction coefficient according to the second embodiment of the invention.

FIG. 14 is a block diagram illustrating an example of the structure of a computer that achieves the thermal flow sensor devices according to the first and second embodiments of the invention.

### DETAILED DESCRIPTION

### [Principle 1 of the Invention]

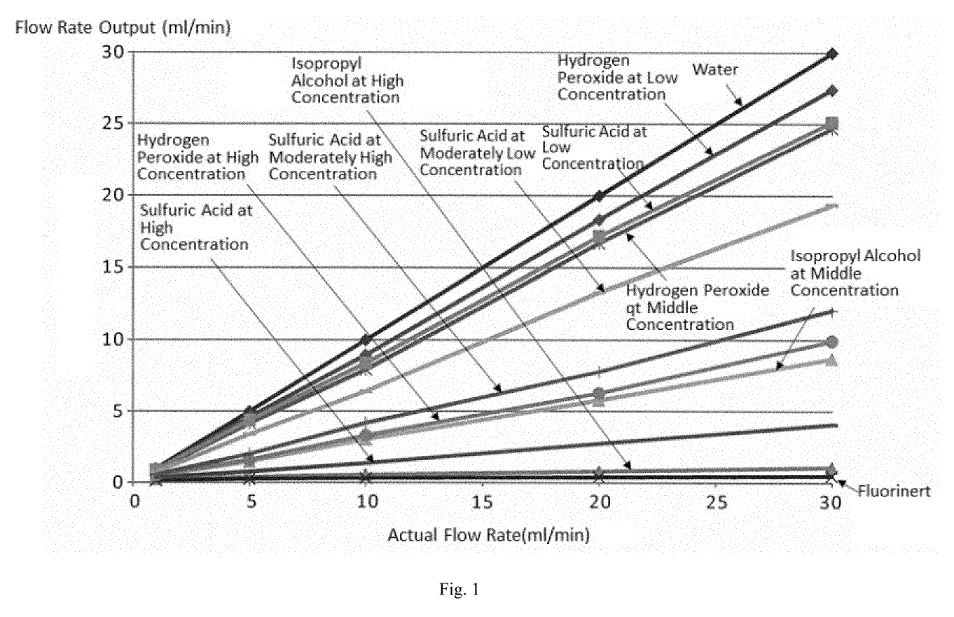

The inventors have detected that, when the characteristics of an actual flow rate versus the thermal flow sensor flow rate output in the case in which, for example, water (H₂O) is used as a reference measurement fluid (that is, in the case in which correction is made using water as a measurement fluid) is compared with the characteristics of the actual flow rate versus the flow rate output in the case in which a fluid other than water circulates through the flow sensor, the flow rate output of the thermal flow sensor is approximately proportional to the actual flow rate in any case, as illustrated in FIG. 1.

In the example in FIG. 1, the types of fluids are water, isopropyl alcohol at middle concentration, isopropyl alcohol at high concentration, Fluorinert (registered trademark), hydrogen peroxide at low concentration, hydrogen peroxide at middle concentration, hydrogen peroxide at high concentration, sulfuric acid at low concentration, sulfuric acid at moderately low concentration, sulfuric acid at moderately high concentration, and sulfuric acid at high concentration and the temperatures of these fluids are set to 25 degrees (Celsius).

In addition, the inventors have focused on the point that, when a valve that controls the flow rate of a fluid based on the flow rate value measured by the thermal flow sensor is disposed upstream or downstream of the thermal flow sensor, if the supply pressure of the fluid is constant (small fluctuations), it can be assumed that the relationship (constant magnification) between the opening degree and the flow rate of the valve can be substantially grasped in advance.

In addition, the inventors have found that, based on the ratio between the magnification of the theoretical flow rate corresponding to at least two valve openings and the magnification of the flow rate output value of the thermal flow sensor detected according to this, the correction coefficient of the thermal flow sensor according to the measurement fluid can be calculated. Accordingly, the invention can reduce effort to set the correction coefficient and reduce fluctuations in the correction coefficient.

### [Principle 2 of the Invention]

By performing the procedure for calculating the correction coefficient periodically, transmitting the correction coefficient to, for example, an upper device, and monitoring this, the detection of the state change (such as occurrence of abnormality) of the measurement fluid can be expected.

### First Embodiment

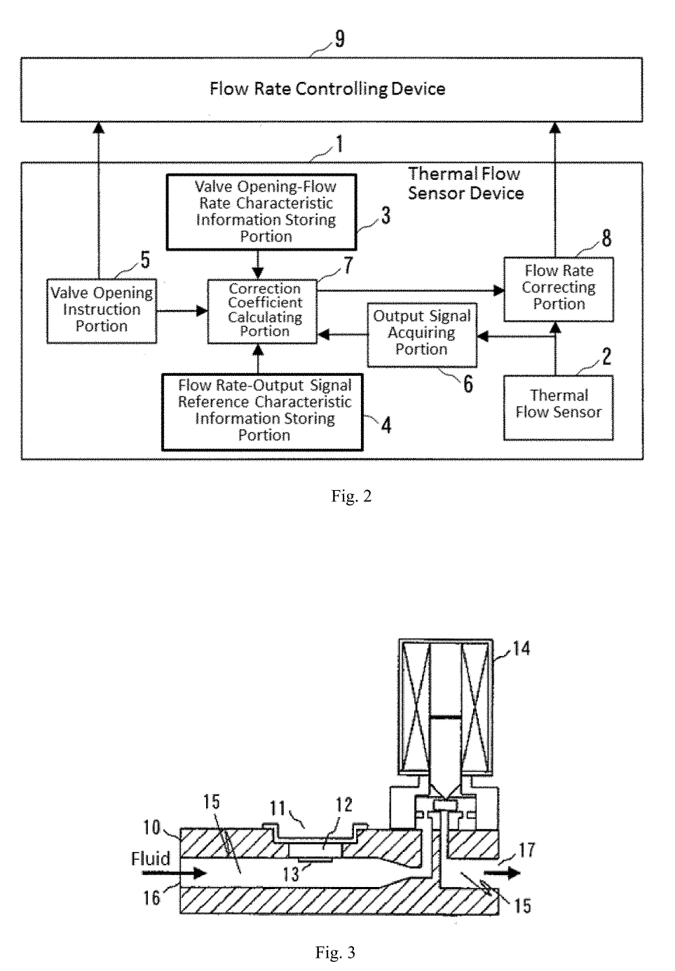

Embodiments of the invention will be described below with reference to the drawings. FIG. 2 is a block diagram illustrating the structure of a thermal flow sensor device according to a first embodiment of the invention. The embodiment is an example corresponding to principle 1 of the invention described above. Although an example of a mass flow controller comprising a thermal flow sensor device is illustrated in the example in FIG. 2, the invention is applicable to a device other than a mass flow controller. Although a valve is disposed downstream of a thermal flow sensor in the mass flow controller, a valve may be disposed upstream of a thermal flow sensor.

A thermal flow sensor device 1 comprises a thermal flow sensor 2, a valve opening-flow rate characteristic information storing portion 3 that stores, in advance, information about the relationship between the valve opening and the flow rate when the supply pressure is constant, a flow rate-output signal reference characteristic information storing portion 4 that stores, in advance, information about the relationship between the flow rate in a measurement fluid used as a reference and the sensor output signal, a valve opening instruction portion 5 that transmits an opening degree instruction signal that specifies at least two predefined valve openings to a controlling device that controls the valve when the correction coefficient is calculated and set, an output signal acquiring portion 6 that acquires the flow rate output value of the thermal flow sensor 2 when the valve opening in accordance with the opening degree instruction signal is achieved, a correction coefficient calculating portion 7 that calculates the magnification between two flow rate output values acquired by the output signal acquiring portion 6, acquires the magnification between the two flow rates corresponding to the two valve openings acquired from information in the valve opening-flow rate characteristic information storing portion 3, and calculates the ratio of the magnification between the two flow rates to the magnification between the two flow rate output values as the correction coefficient, and a flow rate correcting portion 8 that corrects the flow rate by multiplying the flow rate output value of the thermal flow sensor 2 by the correction coefficient.

A flow rate controlling device 9 in FIG. 2 is provided in the mass flow controller together with the valve. FIG. 3 is a cross-sectional view illustrating the structure of the mass flow controller. In FIG. 3, reference numeral 10 represents a main body block of the mass flow controller, reference numeral 11 represents a sensor package, reference numeral 12 represents a head portion of the sensor package 11, reference numeral 13 represents a flow sensor chip mounted in the head portion 12, reference numeral 14 represents a valve, reference numeral 15 represents a flow channel formed in the main body block 10, reference numeral 16 represents an opening at the inlet of the flow channel 15, and reference numeral 17 represents an opening at the outlet of the flow channel 15.

The fluid flows into the flow channel 15 through the opening 16, passes through the valve 14, and is discharged through the opening 17. The thermal flow sensor 2 measures the flow rate of the fluid flowing through the flow channel 15.

The flow rate controlling device 9 of the mass flow controller performs flow rate control based on the flow rate of the fluid measured by the thermal flow sensor device 1. Specifically, the flow rate controlling device 9 drives the valve 14 so that the measured flow rate matches a set value.

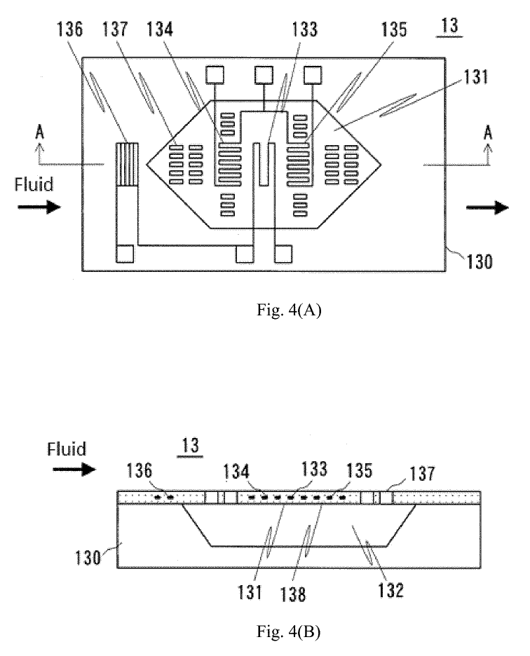

FIG. 4(A) is a plan view illustrating the structure of the flow sensor chip 13 of the thermal flow sensor 2 and FIG. 4(B) is a cross-sectional view illustrating the flow sensor chip 13 in FIG. 4(A) taken along line A-A. In FIG. 4(A) and FIG. 4(B), reference numeral 130 represents a silicon chip as a base, reference numeral 131 represents a diaphragm, made of, for example, silicon nitride, that is formed like a thin plate with a space 132 provided on the upper surface of the silicon chip 130, reference numeral 133 represents a heater formed on the diaphragm 131 as a metal thin film, reference numeral 134 represents a temperature sensor, formed upstream of the heater 133 on the diaphragm 131, that is configured by a heat-sensitive resistor of a metal thin film, reference numeral 135 represents a temperature sensor, formed downstream of the heater 133 on the diaphragm 131, that is configured by a heat-sensitive resistor of a metal thin film, and reference numeral 136 represents an ambient temperature sensor configured by a heat-sensitive resistor of a metal thin film, and reference numeral 137 represents a slit penetrating through the diaphragm 131.

The heater 133 and the temperature sensors 134 to 136 are covered with an insulation layer 138 of a thin film made of, for example, silicon nitride. The ambient temperature sensor 136 is disposed in a position in which the temperature of the fluid can be detected without being affected by heat from the heater 133. The flow sensor chip 13 is mounted in the head portion 12 of the sensor package 11 so that the surface illustrated in FIG. 4(A) faces downward and attached to the main body block 10 so as to be exposed to the measurement fluid.

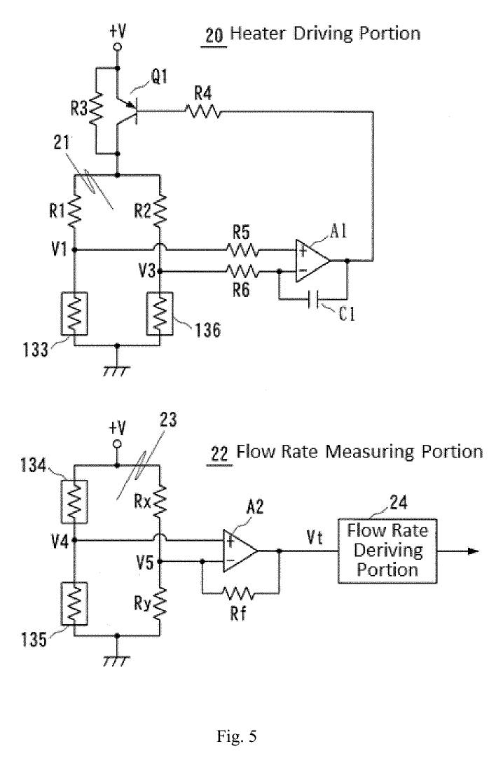

The structure and the principle of the thermal flow sensor 2 described above are disclosed in, for example, PTL 1. FIG. 5 is a block diagram illustrating the structure of the electric circuit of the thermal flow sensor 2. A heater driving portion 20 comprises a bridge circuit 21, a transistor Q1, a differential amplifier A1, fixed resistors R3, R4, R5, and R6, and a capacitor C1. The bridge circuit 21 is a circuit that drives the heater 133 and comprises the heater 133, the ambient temperature sensor 136, and a pair of fixed resistors R1 and R2. A power supply voltage +V is supplied by a predetermined power supply (not illustrated) and applied to the bridge circuit 21 via the transistor Q1.

The differential amplifier A1 detects the bridge output voltage of the bridge circuit 21 according to changes in the resistance values of the heater 133 and the ambient temperature sensor 136 and adjusts the heater driving voltage applied to the bridge circuit 21 by feedback control of the transistor Q1 so that the bridge output voltage becomes zero (0). This causes the heater driving portion 20 to make control so that the heating temperature of the heater 133 always becomes higher than the ambient temperature thereof by a predetermined temperature.

On the other hand, a flow rate measuring portion 22 comprises a bridge circuit 23, a differential amplifier A2, a fixed resistor Rf, and a flow rate deriving portion 24. The bridge circuit 23 comprises the pair of the temperature sensors 134 and 135 and a pair of fixed resistors Rx and Ry. The power supply voltage +V is supplied from a predetermined power supply (not illustrated) and applied to the bridge circuit 23.

The differential amplifier A2 outputs the electropotential difference between output voltages V4 and V5 of the bridge circuit 23 as a sensor output signal (temperature difference signal) Vt equivalent to the temperature difference measured by the temperature sensors 134 and 135. As described above, changes in the resistance values of the pair of temperature sensors 134 and 135 due to heat are converted into a sensor output signal Vt.

The flow rate deriving portion 24 converts the sensor output signal Vt output from the differential amplifier A2 into the value of a flow rate PV of the measurement fluid based on the relationship between the flow rate PV and the sensor output signal Vt stored, in advance, in the flow rate-output signal reference characteristic information storing portion 4, which will be described later.

Next, the characteristic structure of the thermal flow sensor device 1 according to the embodiment will be described. The valve opening-flow rate characteristic information storing portion 3 stores, in advance, information about the relationship between the opening degree of the valve 14 when the supply pressure of the fluid is constant and the flow rate PV of the fluid passing through the valve 14. For example, Japanese Patent No. 5931668 proposes that, when the opening degree of the valve 14 is changed linearly over time, the change in volume of the fluid flowing through the flow channel is smaller for a larger opening degree.

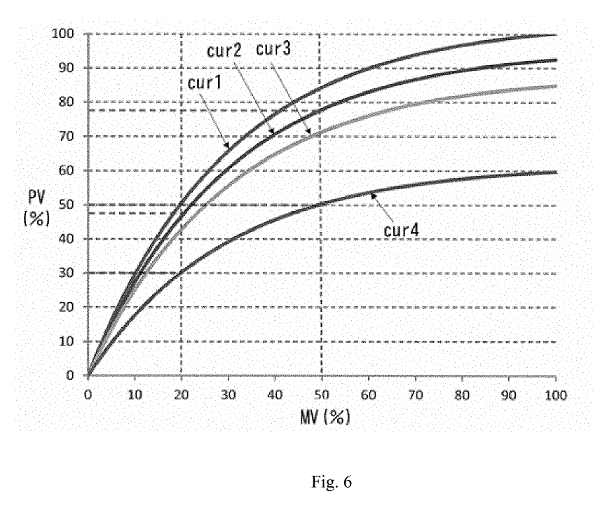

As described above, a non-linear relationship is present between an opening degree MV and the flow rate PV of the valve 14 and the change amount of the flow rate PV relative to the change amount of the opening degree MV becomes smaller as the opening degree is larger. The relationship between the opening degree MV and the flow rate PV is schematically illustrated in FIG. 6. It should be noted here that the opening degree MV and the flow rate PV of the valve 14 are normalized as values from 0 to 100% for convenience in the example in FIG. 6. Since the characteristics illustrated in FIG. 6 are non-linear convergence phenomena, the characteristics can be represented by the following exponential function.

PV=K{1.0−exp(−MV/A)} (1)

As described above, the function that approximates the relationship between the opening degree MV and the flow rate PV of the valve 14 is defined by a constant term (1.0), a term concerning the opening degree MV, and a coefficient K concerning the gain representing the magnitude of the flow rate PV with respect to the opening degree MV. A coefficient A in expression (1) gives a non-linear convergence state. Any of curves curl to cur4 in FIG. 6 assumes that the supply pressure of the fluid is constant and the coefficient A equals 30.0 in any curves. In this case, expression (1) is represented as expression (2).

PV=K{1.0−exp(−MV/30.0)} (2)

It should be noted here that K equals 104.0 for the curve curl. In FIG. 6, for example, the ratio of the flow rate PV of the valve 14 when the opening degree MV equals 50% to the flow rate PV of the valve 14 when the opening degree MV equals 20% is 1.667 for any of the curves curl to cur4. That is, it is possible to determine the magnification Rref of the two flow rates acquired based on the theoretical curve (function) of the opening degree MV versus the flow rate PV to be 1.667.

The valve opening-flow rate characteristic information storing portion 3 may store the theoretical curve (function) that approximates the relationship between the opening degree MV and the flow rate PV of the valve 14, may store the value of the flow rate PV for each opening degree MV acquired based on the function, or may store only the magnification Rref=1.667 acquired based on the function as minimum information. It should be noted here that, for example, the values of the coefficient A and the gain K only need to be determined by performing a flow rate test of the mass flow controller in advance to determine the function.

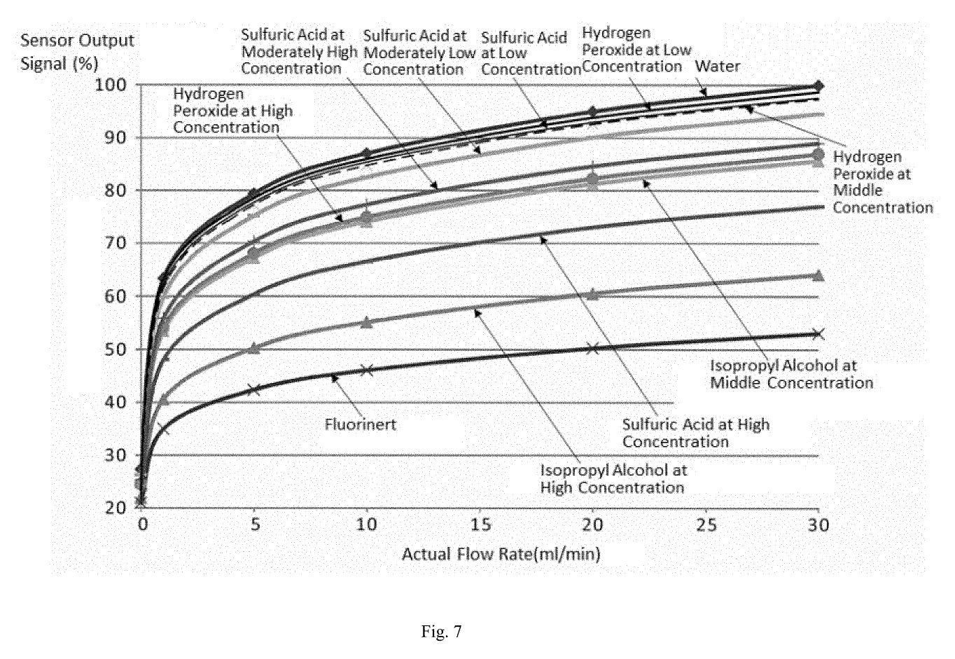

The flow rate-output signal reference characteristic information storing portion 4 stores, in advance, information about the relationship between the flow rate and the sensor output signal of the thermal flow sensor 2 in the measurement fluid (for example, water) used as a reference. FIG. 7 is a drawing illustrating the relationship between the actual flow rate and the sensor output signal Vt when various types of fluids circulate through the flow channel 15. In the example in FIG. 7, the types of fluids are water, isopropyl alcohol at middle concentration, isopropyl alcohol at high concentration, Fluorinert (registered trademark), hydrogen peroxide at low concentration, hydrogen peroxide at middle concentration, hydrogen peroxide at high concentration, sulfuric acid at low concentration, sulfuric acid at moderately low concentration, sulfuric acid at moderately high concentration, and sulfuric acid at high concentration, and the temperatures of these fluids are set to 25 degrees. It should be noted here that the sensor output signal Vt is normalized as a value from 0 to 100%.

When water is used as a reference, it is enough to determine only the characteristics of water in advance and store the relationship between the actual flow rate and the sensor output signal Vt when the measurement fluid is water in the flow rate-output signal reference characteristic information storing portion 4. FIG. 7 is a characteristic diagram drawn by assuming the sensor output signal Vt when the actual flow rate of water is 30 ml/min to be 100%.

As described above, the relationship between the actual flow rate and the flow rate output (output of the flow rate deriving portion 24) of the thermal flow sensor 2 when the reference measurement fluid is water is illustrated in FIG. 1. Since the flow rate output of the thermal flow sensor 2 is substantially proportional to the actual flow rate in any fluids as illustrated in FIG. 1, the proportional coefficient of this characteristic relates to the correction coefficient obtained in the embodiment.

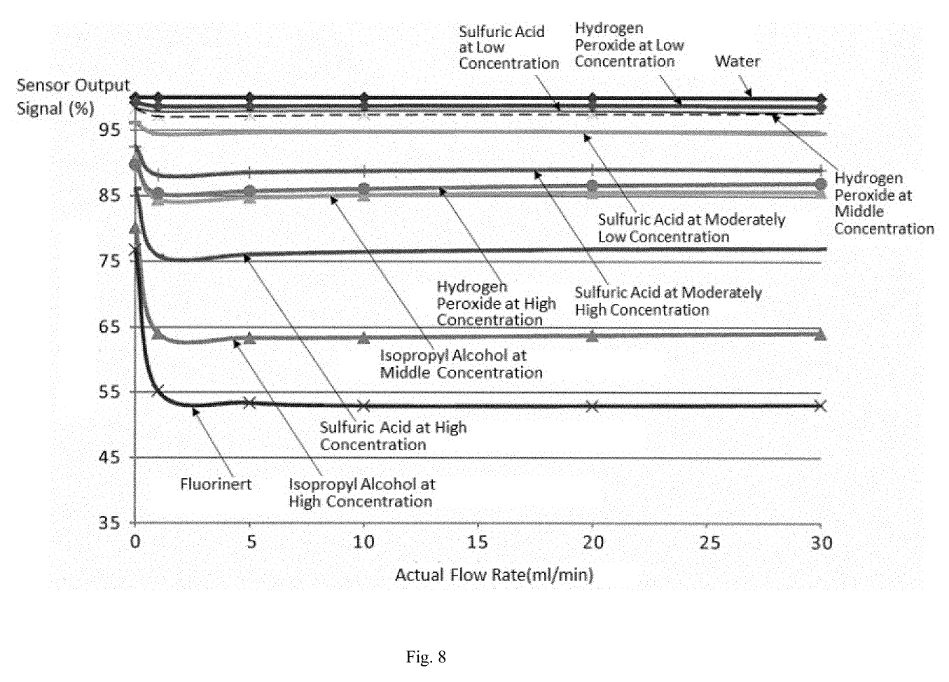

FIG. 8 is a drawing illustrating the relationship between the actual flow rates and the sensor output signals Vt of various types of fluids when using the characteristic of water in FIG. 7 as a reference (when the sensor output signal Vt for each flow rate is 100% in the case in which the measurement fluid is water). It is clear from FIG. 8 that, if correction is made based on a substantially constant correction coefficient using the characteristics of water as a reference, the flow rate measurement precision can be obtained to some extent in the almost entire flow rate region.

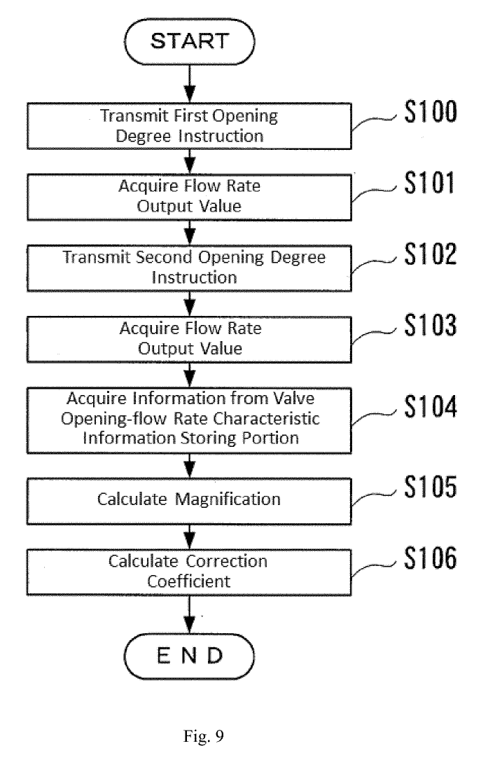

FIG. 9 is a flowchart illustrating the operations of the valve opening instruction portion 5, the output signal acquiring portion 6, and the correction coefficient calculating portion 7.

The valve opening instruction portion 5 transmits the opening degree instruction signal to the flow rate controlling device 9 so that the valve 14 reaches a predefined first opening degree MV1 (for example, MV1 is 20%) when automatically setting the correction coefficient (step S100 in FIG. 9).

When receiving the opening degree instruction signal from the valve opening instruction portion 5, the flow rate controlling device 9 preferentially performs the processing corresponding to this opening degree instruction signal. That is, the flow rate controlling device 9 once stops the flow rate control described above and causes the valve 14 to reach the opening degree MV1 specified by the opening degree instruction signal. Then, the flow rate controlling device 9 returns to the flow rate control a certain time after receiving the opening degree instruction signal. This certain time is set to be long enough, for example, for the output signal acquiring portion 6 to acquire the flow rate output value as described later.

The output signal acquiring portion 6 acquires the flow rate output value PV1 output from the flow rate deriving portion 24 of the thermal flow sensor 2 when the valve 14 has the first opening degree MV1 (=20%) (step S101 in FIG. 9). It should be noted here that the output signal acquiring portion 6 preferably acquires the flow rate output value of the thermal flow sensor 2 a predetermined waiting time after transmission of the opening degree instruction signal to wait for the convergence of flow rate fluctuations caused when the opening degree of the valve 14 changes to MV1.

After the output signal acquiring portion 6 acquires the flow rate output value, the valve opening instruction portion 5 transmits the opening degree instruction signal to the flow rate controlling device 9 so that the valve 14 reaches a predefined second opening degree MV2 (MV2 is not equal to MV1 and, for example, 50%) (step S102 in FIG. 9).

As in the case in which MV1 is 20%, the flow rate controlling device 9 once stops the flow rate control and causes the valve 14 to reach the opening degree MV2 specified by the opening degree instruction signal. Then, the flow rate controlling device 9 returns to the flow rate control a certain time after receiving the opening degree instruction signal.

The output signal acquiring portion 6 acquires the flow rate output value PV2 output from the flow rate deriving portion 24 of the thermal flow sensor 2 when the valve 14 has the second opening degree MV2 (=50%) (step S103 in FIG. 9). As in the case in which MV1 is 20%, the output signal acquiring portion 6 preferably acquires the flow rate output value of the thermal flow sensor 2 a predetermined waiting time after transmission of the opening degree instruction signal.

It should be noted here that the magnification Rref=1.667 described above becomes R=PV2ref/PV1ref when it is assumed that the reference flow rate is PV1ref and the target flow rate that determines the magnification Rref is PV2ref. When the valve opening-flow rate characteristic information storing portion 3 stores only the magnifications Rref (=1.667) between two flow rates PV2ref and PV1ref acquired based on the theoretical curve (function) of the opening degree MV versus the flow rate PV, the first and second opening degrees MV1 and MV2 only need to be defined so that the valve opening corresponding to the flow rate PV1ref equals the first opening degree MV1 on the theoretical curve and the valve opening corresponding to the flow rate PV2ref equals the second opening degree MV2 on the theoretical curve. Accordingly, it is enough to transmit the opening degree instruction signal and acquire the flow rate output value at least twice.

After the output signal acquiring portion 6 has acquired the flow rate output value, the correction coefficient calculating portion 7 acquires information stored in the valve opening-flow rate characteristic information storing portion 3 (step S104 in FIG. 9) and calculates the magnification R (=PV2/PV1) between the two flow rate output values PV2 and PV1 acquired by the output signal acquiring portion 6 (step S105 in FIG. 9).

Then, the correction coefficient calculating portion 7 calculates the ratio Rref/R of the magnification Rref that can be obtained from information acquired from the valve opening-flow rate characteristic information storing portion 3 to the calculated magnification R as a correction coefficient C and sets this correction coefficient C in the flow rate correcting portion 8 (step S106 in FIG. 9).

For example, when the magnification R is 1.275, the correction coefficient C is calculated as Rref/R=1.677/1.275=1.307 (130.7%). This value is the correction coefficient C acquired automatically when the measurement fluid is sulfuric acid at high concentration (or a fluid having substantially the same thermal conductivity) in FIG. 8.

It should be noted here that, when the valve opening-flow rate characteristic information storing portion 3 stores the theoretical curve (function) of the opening degree MV versus the flow rate PV instead of the magnification Rref, the correction coefficient calculating portion 7 only needs to calculate the magnification Rref by obtaining the flow rate PV1ref corresponding to the first opening degree MV1 on the theoretical curve and the flow rate PV2ref corresponding to the second opening degree MV2 on the theoretical curve.

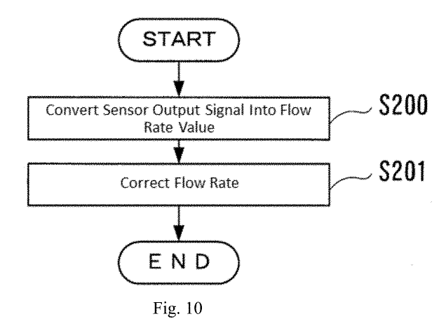

FIG. 10 is a flowchart illustrating the operations of the flow rate deriving portion 24 of the thermal flow sensor 2 and the flow rate correcting portion 8.

The flow rate deriving portion 24 converts the sensor output signal Vt output from the differential amplifier A2 into the value of the flow rate PV based on the relationship between the flow rate PV and the sensor output signal Vt stored in the flow rate-output signal reference characteristic information storing portion 4 (step S200 in FIG. 10).

The flow rate correcting portion 8 corrects the flow rate PV by multiplying the value of the flow rate PV output from the flow rate deriving portion 24 of the thermal flow sensor 2 by the correction coefficient C (step S201 in FIG. 10). It should be noted here that the initial value (value when the measurement fluid is water) of the correction coefficient C before being set by the correction coefficient calculating portion 7 is 1.

The flow rate deriving portion 24 and the flow rate correcting portion 8 perform the processing of steps S200 and S201 every certain time during flow rate control (flow rate measurement).

In this way, the embodiment can reduce effort to set the correction coefficient C and fluctuations in the correction coefficient C.

It should be noted here that the processing described in FIG. 9 may be started at a timing at which an instruction for starting the setting is received from the operator or when a predefined timing is reached as in a second embodiment that will be described later.

### Second Embodiment

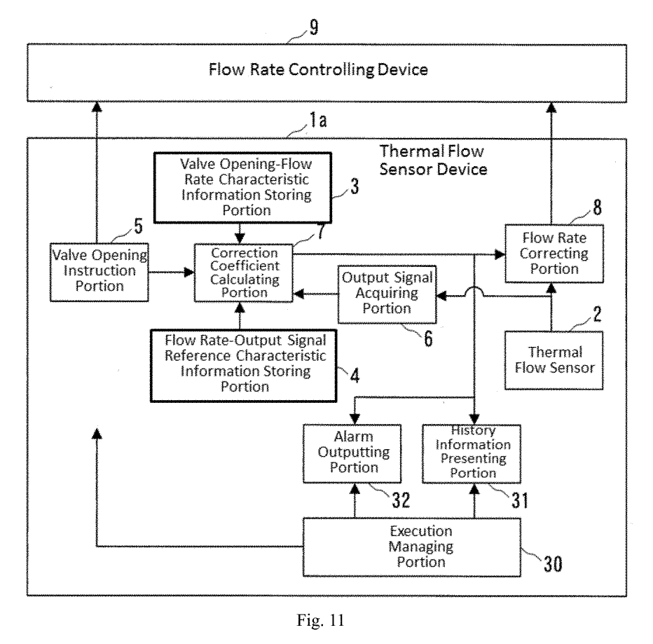

Next, a second embodiment of the invention will be described. FIG. 11 is a block diagram illustrating the structure of a thermal flow sensor device according to a second embodiment of the invention and the same components as in FIG. 2 are given the same reference numerals. The embodiment is an example corresponding to principle 2 of the invention described above.

A thermal flow sensor device 1a according to the embodiment comprises the thermal flow sensor 2, the valve opening-flow rate characteristic information storing portion 3, the flow rate-output signal reference characteristic information storing portion 4, the valve opening instruction portion 5, the output signal acquiring portion 6, the correction coefficient calculating portion 7, the flow rate correcting portion 8, an execution managing portion 30 that performs control and management so as to perform calculating and setting processing of the correction coefficient C at predefined timing, a history information presenting portion 31 that presents history information of the correction coefficient C from past to present calculated by the correction coefficient calculating portion 7, and an alarm outputting portion 32 that outputs an alarm when a deviation degree of the correction coefficient C calculated by the correction coefficient calculating portion 7 from a normal value is equal to or more than a defined amount.

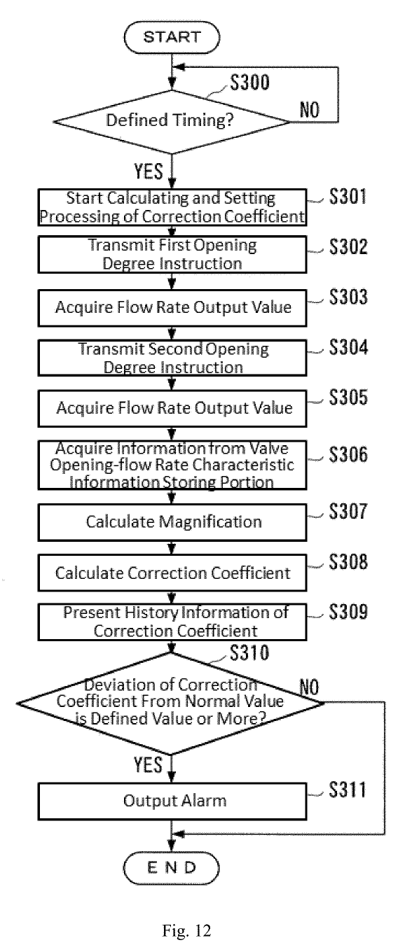

FIG. 12 is a flowchart illustrating the operations of the valve opening instruction portion 5, the output signal acquiring portion 6, the correction coefficient calculating portion 7, the execution managing portion 30, the history information presenting portion 31, and the alarm outputting portion 32 according to the embodiment.

When predefined timing is reached (YES in step S300 in FIG. 12), the execution managing portion 30 outputs an instruction for starting calculating and setting processing of the correction coefficient to the valve opening instruction portion 5, the output signal acquiring portion 6, and the correction coefficient calculating portion 7 (step S301 in FIG. 12).

The operations of the valve opening instruction portion 5, the output signal acquiring portion 6, and the correction coefficient calculating portion 7 (steps S302 to S308 in FIG. 12) are as described in steps S100 to S106 (shown in FIG. 9).

The history information presenting portion 31 stores the correction coefficient C from past to present calculated by the correction coefficient calculating portion 7 and presents the history information of the correction coefficient C from past to present (step S309 in FIG. 12).

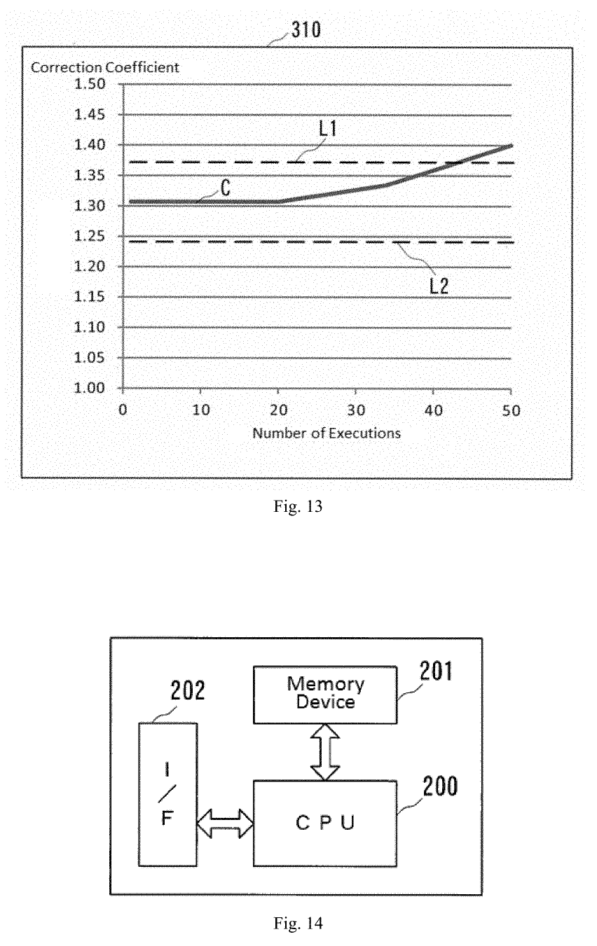

FIG. 13 is a diagram illustrating a presentation example of the history information of the correction coefficient C. In the example in FIG. 13, a graph having the horizontal axis indicating the number of times the correction coefficient C has been calculated and set and the vertical axis indicating the correction coefficient C is displayed on a screen 310 displayed by the history information presenting portion 31. In addition, the history information presenting portion 31 displays a line L1 indicating±5 percent and a line L2 indicating −5 percent of the correction coefficient C having been calculated and set earliest on the screen 310.

When a deviation degree of the latest correction coefficient C calculated by the correction coefficient calculating portion 7 from the normal value (generally, the correction coefficient C calculated and stored when the thermal flow sensor device is used initially) is equal to or more than a defined amount (YES in step S310 in FIG. 12), the alarm outputting portion 32 outputs an alarm (step S311 in FIG. 12).

For example, the alarm outputting portion 32 outputs an alarm when the latest correction coefficient C deviates ±5% or more from the normal value. The method for outputting an alarm is, for example, a method that displays content for reporting occurrence of an alarm or transmits information for reporting occurrence of an alarm to the outside.

In this way, the embodiment can be expected to detect the state change (such as occurrence of an abnormality) of the measurement fluid by monitoring the correction coefficient C calculated and set by the correction coefficient calculating portion 7.

Although an example of a mass flow controller comprising a thermal flow sensor device is illustrated in the first and second embodiments as described above, the invention is applicable to a device other than a mass flow controller. In addition, a valve may be provided upstream or downstream of the thermal flow sensor 2.

In the thermal flow sensor devices according to the first and second embodiments, at least the valve opening-flow rate characteristic information storing portion 3, the flow rate-output signal reference characteristic information storing portion 4, the valve opening instruction portion 5, the output signal acquiring portion 6, the correction coefficient calculating portion 7, the flow rate correcting portion 8, the execution managing portion 30, the history information presenting portion 31, the alarm outputting portion 32, and the flow rate deriving portion 24 may be achieved by a computer having a CPU (Central Processing Unit), a memory device, and an interface and programs that control these hardware resources.

An example of the structure of this computer will be described in FIG. 14. The computer comprises a CPU 200, a memory device 201, an interface device (abbreviated below as an I/F) 202. The flow rate measuring portion 22 of the thermal flow sensor 2 and the flow rate controlling device 9 are connected to the I/F 202. In the computer described above, a program that achieves the flow rate correcting method according to the invention is stored in the memory device 201. The CPU 200 performs the processing described in the first and second embodiments according to a program stored in the memory device 201. In addition, the flow rate controlling device 9 can also be achieved by a computer and a program as is well known.

### DESCRIPTION OF REFERENCE NUMERALS AND SIGNS

1: thermal flow sensor device, 2: thermal flow sensor, 3: valve opening-flow rate characteristic information storing portion, 4: flow rate-output signal reference characteristic information storing portion, 5: valve opening instruction portion, 6: output signal acquiring portion, 7: correction coefficient calculating portion, 8: flow rate correcting portion, 9: flow rate controlling device, 10: main body block, 11: sensor package, 12: head portion, 13: flow sensor chip, 14: valve, 15: flow channel, 16, 17: opening, 20: heater driving portion, 21, 23: bridge circuit, 22: flow rate measuring portion, 24: flow rate deriving portion, 30: execution managing portion, 31: history information presenting portion, 32: alarm outputting portion, 130: silicon chip, 131: diaphragm, 132: space, 133: heater, 134, 135: temperature sensor, 136: ambient temperature sensor, 137: slit, 138: insulation layer

1. A thermal flow sensor device comprising:
a thermal flow sensor configured to output a sensor output signal acquired from a temperature sensor that measures a temperature of a measurement fluid, the thermal flow sensor being disposed in a flow channel through which the measurement fluid circulates;
a valve opening-flow rate characteristic information storing portion configured to store, in advance, information about a relationship between an opening degree of a valve disposed in a part of the flow channel upstream or downstream of the thermal flow sensor and a flow rate of the measurement fluid;
a flow rate-output signal reference characteristic information storing portion configured to store, in advance, information about a relationship between the flow rate in the measurement fluid used as a reference and the sensor output signal;
a flow rate deriving portion configured to convert the sensor output signal to a value of the flow rate based on the information stored in the flow rate-output signal reference characteristic information storing portion;
a flow rate correcting portion configured to correct the flow rate by multiplying a flow rate output value of the flow rate deriving portion by a correction coefficient;
a valve opening instruction portion configured to transmit an opening degree instruction signal that specifies at least two predefined valve openings to a controlling device that controls the valve when the correction coefficient is calculated and set;
an output signal acquiring portion configured to acquire two flow rate output values of the flow rate deriving portion when each of the at least two predefined valve openings in accordance with the opening degree instruction signal is achieved; and
a correction coefficient calculating portion configured to calculate a magnification between the two flow rate output values acquired by the output signal acquiring portion, acquire a magnification between two flow rates corresponding to the at least two predefined valve openings acquired from the information in the valve opening-flow rate characteristic information storing portion, calculate a ratio of the magnification between the two flow rates to a magnification between the two flow rate output values as the correction coefficient, and set the calculated correction coefficient in the flow rate correcting portion.

2. The thermal flow sensor device according to claim 1,
wherein the valve opening-flow rate characteristic information storing portion stores the magnification between the two flow rates acquired from a theoretical curve that approximates a relationship between the opening degree of the valve and the flow rate of the measurement fluid.

3. The thermal flow sensor device according to claim 1, further comprising:
an execution managing portion configured to perform control and management so as to perform calculating and setting processing of the correction coefficient at one or more predefined timings;
a history information presenting portion configured to present history information of the correction coefficient from past to present calculated by the correction coefficient calculating portion; and
an alarm outputting portion configured to output an alarm when a deviation degree of the correction coefficient calculated by the correction coefficient calculating portion from a normal value is equal to or more than a specified amount.

4. A flow rate correcting method comprising:
converting a sensor output signal of a thermal flow sensor disposed in a flow channel through which a measurement fluid circulates into a flow rate output value with reference to a flow rate-output signal reference characteristic information storing portion that stores, in advance, information about a relationship between a flow rate in the measurement fluid used as a reference and a sensor output signal;
correcting the flow rate by multiplying the flow rate output value by a correction coefficient;
transmitting an opening degree instruction signal that specifies at least two predefined valve openings to a controlling device that controls a valve disposed in a part of the flow channel upstream or downstream of the thermal flow sensor when the correction coefficient is calculated and set;
acquiring two flow rate output values when each of the at least two predefined valve openings in accordance with the opening degree instruction signal is achieved; and
calculating a magnification between the two acquired flow rate output values, acquiring a magnification between two flow rates corresponding to the at least two predefined valve openings with reference to a valve opening-flow rate characteristic information storing portion that stores, in advance, information about a relationship between an opening degree of the valve and the flow rate of the measurement fluid, and calculating a ratio of the magnification between the two flow rates to the magnification between the two flow rate output values as the correction coefficient.

5. The flow rate correcting method according to claim 4,
wherein the information stored in the valve opening-flow rate characteristic information storing portion in advance is the magnification between the two flow rates acquired based on a theoretical curve that approximates the relationship between the opening degree of the valve and the flow rate of the measurement fluid.

6. The flow rate correcting method according to claim 4, further comprising:
instructing execution of calculating and setting processing of the correction coefficient at predefined timing;
presenting the history information of the calculated correction coefficient from past to present; and
outputting an alarm when a deviation degree of the calculated correction coefficient from a normal value is equal to or more than a defined amount.
